(19) United States
(12) Patent Application Publication
(10) Pub. No.: US 2023/0297860 A1
(43) Pub. Date: Sep. 21, 2023

(54) SYSTEM AND METHOD ENABLING APPLICATION OF AUTONOMOUS ECONOMIC AGENTS

(71) Applicant: UVUE Ltd, Bury St Edmunds (GB)

(72) Inventors: Ali Hosseini, Bury St Edmunds (GB); Humayun Munir Sheikh, Bury St Edmunds (GB); Kamal Ved, Bury St Edmunds (GB)

(21) Appl. No.: 18/324,024

(22) Filed: May 25, 2023

Related U.S. Application Data
(63) Continuation-in-part of application No. 18/180,896, filed on Mar. 9, 2023.
(63) Continuation-in-part of application No. 17/234,932, filed on Apr. 20, 2021.

(51) Int. Cl. G06N 5/043; G06N 20/00

(52) U.S. Cl. CPC G06N 5/043; G06N 20/00

(57) ABSTRACT

Disclosed is system enabling application of autonomous economic agents (AEAs) across problem domains. The system comprises decentralised computing network configured to implement software framework including domain-independent protocol specification language (DIPSL), protocol generator (PG), AEAs communicably coupled with micro- agent s; and external computing arrangement comprising external computing device (ECDs) that is part of distributed ledger arrangement. Micro- agent is configured to generate invocation of PG for generating protocol(s) for protocol specification (PS). ECDs are configured to receive, from micro-AEA, invocation of PG, generate insight corresponding to action, using external machine learning model and/or co-learning software module (CSM) and transmit insight to micro- agent; micro- agent configured to receive insight from ECDs and transmit metadata thereto, upon receiving metadata from micro- agent, ECDs is configured to generate inference by applying insight and metadata to external machine learning model and/or CSM, transmit inference to micro- agent, and PG is configured to generate implementation of protocol(s) to implement PS using inference and DIPSL.

### CROSS-REFERENCE TO RELATED APPLICATIONS

This application is a continuation-in-part of U.S. Pat. Application Serial Nos. 17234932 and 18180896, which are also incorporated herein by reference.

### TECHNICAL FIELD

The present disclosure relates generally to systems that, in operation, enable application of autonomous economic agents (AEAs) across a plurality of problem domains. The present disclosure also relates to methods for enabling application of autonomous economic agents (AEAs) across a plurality of problem domains.

### BACKGROUND

The field of artificial intelligence has advanced significantly in recent years, particularly in the development of autonomous economic agents (AEAs) that can interact with each other. However, in order to ensure successful interaction, well-defined protocols for these autonomous economic agents (AEAs) are required. Currently, existing protocol languages for multi-agent systems are limited in implementation leading to interoperability issues during their interactions.

Additionally, there is a growing need for collaborative machine-learning techniques that allow different parties such as the autonomous economic agents (AEAs) to build a shared machine-learning algorithm without sharing raw data thereof. Existing machine learning techniques such as a federated learning rely on a trusted central party to aggregate all information into a global model, which poses a risk of control being in the hands of a single party. Moreover, said federated learning technique may not be practical or feasible for certain applications where the parties are not willing or able to share their raw data due to privacy, legal, or other reasons.

There exist other existing techniques such as a differential privacy technique that provide privacy-preserving solutions for machine learning techniques. However, said techniques have certain limitations that may prevent them from fully protecting the sensitive data of the autonomous economic agents (AEAs). Moreover, said techniques often require significant computational resources, which can lead to slow and inefficient training processes. Additionally, said techniques may not be suitable for applications where the parties require more control over the training process and the resulting model. Furthermore, existing ML algorithms or models assume that training and test data will be independent and identically distributed, meaning that the data points are sampled randomly from some parent distribution and that this distribution does not change over time or with respect to partitioning of the data into test and training sets. However, in many real-world scenarios, data from different sources can have significant variations, leading to poor model performance.

Therefore, in light of the foregoing technical problems, there exists a need to overcome the aforementioned problems associated with existing autonomous economic agents (AEAs) and enable secure, privacy-preserving collaborations thereof without relying on a trusted central party.

### SUMMARY

The present disclosure seeks to provide a system that, in operation, enables application of autonomous economic agents (AEAs) across a plurality of problem domains. The present disclosure also seeks to provide a method for enabling application of autonomous economic agents (AEAs) across a plurality of problem domains. An aim of the present disclosure is to provide a solution that overcomes at least partially the problems encountered in prior art.

In one aspect, there is provided a system that, in operation, enables application of autonomous economic agents (AEAs) across a plurality of problem domains, the system comprising:
a decentralised computing network configured to implement a software framework, wherein the software framework includes a domain-independent protocol specification language, a protocol generator and a plurality of modular and extensible software modules configured to operate as a plurality of autonomous economic agents (AEAs), and wherein the plurality of autonomous economic agents (AEAs) are communicably coupled with a plurality of micro-agents (micro-AEAs), the plurality of micro-agents (micro-AEAs) being communicably coupled with each other; and
an external computing arrangement comprising a plurality of external computing device, wherein the plurality of external computing devices is part of a distributed ledger arrangement upon which a co-learning software module and a plurality of external machine learning (ML) models are implemented, wherein the co-learning software module is communicably coupled to the plurality of external machine learning models, and wherein within the system:
   a given micro-agent (micro-AEA), is configured to generate an invocation of the protocol generator for generating at least one protocol for a protocol specification, upon receiving a service request to perform an action from a clientagent (Client-AEA), to incorporate a given external machine learning model from amongst the plurality of external machine learning models, and to transmit the protocol specification to the plurality of external computing devices;
   the plurality of external computing devices is configured to receive, from the given micro-agent (micro-AEA), the invocation for generating the at least one protocol for the protocol specification and to generate an insight corresponding to the action, using the given external machine learning model and/or the co-learning software module and to transmit the insight to the given micro-agent (micro-AEA);
   the given micro-agent (micro-AEA) is configured to receive the insight from the plurality of external computing devices and to transmit metadata corresponding to the protocol specification and the received insight to the plurality of external computing devices;
   upon receiving the metadata from the given micro-agent (micro-AEA), the plurality of external computing devices is configured to generate an inference by applying the insight and the metadata to the given external machine learning model and/or the co-learning software module, and to transmit the inference to the given micro-agent (micro-AEA); and
   the given protocol generator is configured to generate an implementation of the at least one protocol to implement the protocol specification using the inference and the domain-independent protocol specification language.

Optionally, the given micro-agent (micro-AEA) is configured to execute the generated at least one protocol such that the action associated with the service request, received by the client- agent, is executed.

Optionally, when the co-learning software module is configured to generate the insight corresponding to the action, the co-learning software module is configured to engage with the plurality of external machine learning models for receiving learnings of the plurality of external machine learning models, wherein the engagement of the co-learning software module with the plurality of external machine learning models occurs without sharing metadata of any external machine learning model with other external machine learning models.

Optionally, when the co-learning software module is configured to generate the inference related at least to the protocol specification, the co-learning software module is configured to analyse the metadata and the learnings of the plurality of external machine learning models in respect of each other, and to generate the inference based on said analysis.

Optionally, the given external machine learning model is communicably coupled to at least one other external ML model of a second micro-agent (micro-AEA), and wherein when the given external machine learning model is configured to generate the insight corresponding to the action, the given external machine learning model is configured to engage with the at least one other external machine learning model for receiving learnings of the at least one other external machine learning model, wherein the engagement of the given external machine learning model with the at least one other external machine learning model occurs without sharing metadata of the at least one other external machine learning model with the given external machine learning model.

Optionally, when the given external machine learning model is configured to generate the inference related at least to the protocol specification, the given external machine learning model is configured to analyse the metadata, its learnings, and the learnings of the at least one other external machine learning model in respect of each other, and generate the inference based on said analysis.

Optionally, the insight comprises at least one of:
a requirement to generate the implementation of the at least one protocol corresponding to the protocol specification, to fulfil the service request;
a possibility to reuse at least one of: one or more existing protocols for the given micro-agent (micro-AEA), one or more existing skills of the given micro-agent (micro-AEA), one or more existing connections supported by the given micro-agent (micro-AEA); and
a requirement to generate at least one of: a new protocol, a new connection, a new skill.

Optionally, the metadata comprises at least one of: a technological setup of the given micro-agent (micro-AEA), one or more protocols for the given micro-agent (micro-AEA), one or more skills of the given micro-agent (micro-AEA), one or more connections supported by the given micro-agent (micro-AEA), the service request received by the given micro-agent (micro-AEA).

Optionally, the technological setup of the given micro-agent (micro-AEA) comprises at least one of: a programming language in which the given micro-agent (micro-AEA) is created, an operating system of the given micro-agent (micro-AEA), a library available to the given micro-agent (micro-AEA), an amount of computational resources available with the given micro-agent (micro-AEA), a platform that the given micro-agent (micro-AEA) runs on.

Optionally, the inference comprises at least one of:
a recommendation of how to produce the implementation of the at least one protocol corresponding to the protocol specification, to fulfil the service request;
a recommendation of how to combine at least one of: one or more existing protocols for the given micro-agent (micro-AEA), one or more existing skills of the given micro-agent (micro-AEA), one or more existing connections supported by the given micro-agent (micro-AEA), to create a new functionality for the clientagent (client-AEA) corresponding to the service request; and
a recommendation of how to generate at least one of: a new protocol, a new connection, a new skill, to fulfil the service request.

Optionally, the decentralised computing network comprises a plurality of computing devices that are communicably coupled to each other, and wherein each of the plurality of computing devices comprises at least one processor, at least one memory device, and a communication interface.

In another aspect, the present disclosure further provides a method for enabling application of autonomous economic agents (AEAs) across a plurality of problem domains, the method comprising:
generating, from a given micro-agent (micro-AEA) communicably coupled with a plurality of modular and extensible software modules configured to operate as a plurality of autonomous economic agents (AEAs) of a software framework, an invocation of a protocol generator of the software framework for a protocol specification, upon receiving a service request to perform an action from a clientagent (client-AEA), incorporating a given external machine learning model from amongst a plurality of external machine learning models with its corresponding clientagent and transmitting the protocol specification to the plurality of external computing devices;
receiving, using the plurality of external computing devices, the invocation for generating the at least one protocol for the protocol specification from the given micro-agent (micro-AEA), and generating an insight corresponding to the action, using the plurality of external computing devices and transmitting the insight to the given micro-agent (micro-AEA), wherein the plurality of external computing devices uses the given external ML model and/or a co-learning software module that is communicably coupled to the plurality of external ML models, wherein the given external ML model and the co-learning software module are implemented upon a distributed ledger arrangement;
receiving, from the given micro-agent (micro-AEA), the insight from the plurality of external computing devices and transmitting metadata corresponding to the protocol specification and the received insight to the plurality of external computing devices;
generating an inference using the plurality of external computing devices, upon receiving the metadata from the given micro-agent (micro-AEA), by applying the insight and the metadata to using the given external ML model and/or the co-learning software module and transmitting the inference to the given micro-agent (micro-AEA); and
generating an implementation of the at least one protocol to implement the protocol specification using the inference and a domain-independent protocol specification language of the software framework.

Optionally, the method further comprises executing the generated at least one protocol using the given micro-agent (micro-AEA) such that the action associated with the service request, received by the client- agent, is executed.

Optionally, when the co-learning software module implements the step of generating the insight corresponding to the action, the method comprises engaging with the plurality of external machine learning (ML) models for receiving learnings of the plurality of external machine learning (ML) models, wherein the engagement of the co-learning software module with the plurality of external machine learning (ML) models occurs without sharing metadata of any external machine learning (ML) model with other external ML models.

Optionally, the co-learning software module implements the step of generating the inference related at least to the protocol specification, and wherein the method comprises analysing the metadata and the learnings of the plurality of external machine learning (ML) models in respect of each other, and generating the inference based on said analysis.

Optionally, the given external machine learning (ML) model is communicably coupled to at least one other external ML model of a second micro-agent (micro-AEA), and wherein when the given external machine learning (ML) model implements the step of generating the insight corresponding to the action, the method comprises engaging the given external machine learning (ML) model with the at least one other external machine learning (ML) model for receiving learnings of the at least one other external machine learning (ML) model, wherein the engagement of the given external machine learning (ML) model with the at least one other external machine learning (ML) model occurs without sharing metadata of the at least one other external machine learning (ML) model with the given external machine learning (ML) model.

Optionally, the given external machine learning (ML) model implements the step of generating the inference related at least to the protocol specification, and wherein the method comprises analysing the metadata, learnings of the given external machine learning (ML) model, and the learnings of the at least one other external machine learning (ML) model in respect of each other, and generating the inference based on said analysis.

Optionally, the insight comprises at least one of:
a requirement to generate the implementation of the at least one protocol corresponding to the protocol specification, to fulfil the service request;
a possibility to reuse at least one of: one or more existing protocols for the given micro-agent (micro-AEA), one or more existing skills of the given micro-agent (micro-AEA), one or more existing connections supported by the given micro-agent (micro-AEA); and
a requirement to generate at least one of: a new protocol, a new connection, a new skill.

Optionally, the metadata comprises at least one of: a technological setup of the given micro-agent (micro-AEA), one or more protocols for the given micro-agent (micro-AEA), one or more skills of the given micro-agent (micro-AEA), one or more connections supported by the given micro-agent (micro-AEA), the service request received by the given micro-agent (micro-AEA).

Optionally, the inference comprises at least one of:
a recommendation of how to produce the implementation of the at least one protocol corresponding to the protocol specification, to fulfil the service request;
a recommendation of how to combine at least one of: one or more existing protocols for the given micro-agent (micro-AEA), one or more existing skills of the given micro-agent (micro-AEA), one or more existing connections supported by the given micro-agent (micro-AEA), to create a new functionality for the client- agent (client-AEA) corresponding to the service request; and
a recommendation of how to generate at least one of: a new protocol, a new connection, a new skill, to fulfil the service request.

Embodiments of the present disclosure substantially eliminate or at least partially address the aforementioned problems in the prior art, and enable application of autonomous economic agents (AEAs) across a plurality of problem domains. Additionally, the system employs the micro-agents (micro-AEAs) to incorporate an external capability for insight, inference, machine learning, and decision-making for the action. Moreover, the system employs the co-learning software module and the plurality of external machine learning (ML) models for coordinating collective learning between the Autonomous economic agents (AEAs) and providing accountable management of collective learning between the Autonomous economic agents (AEAs) that ensure efficient utilisation of resources of the Autonomous economic agents (AEAs). As a result, enhance stability and performance in the operation of the system are achieved. Furthermore, the co-learning software module enables collective learning of the micro-agents (micro-AEAs)without sharing of the metadata thereof. Furthermore, the system provides computational benefits and also enables the Autonomous economic agents (AEAs) to set-up secure, encrypted channels with each other.

Additional aspects, advantages, features, and objects of the present disclosure would be made apparent from the drawings and the detailed description of the illustrative embodiments construed in conjunction with the appended claims that follow. It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1A is a block diagram illustrating a system that, in operation, enables application of autonomous economic agents (AEAs) across a plurality of problem domains, in accordance with an embodiment of the present disclosure;

FIG. 1B illustrates an architecture of a decentralised computing network of the system of FIG. 1A, in accordance with an embodiment of the present disclosure; and

FIG. 2 is a flowchart depicting steps of a method for enabling application of autonomous economic agents (AEAs) across a plurality of problem domains, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

Throughout the present disclosure the term “autonomous economic agent” (referred to herein later as “AEAs”) as used herein, relates to a software module, or any device comprising at least one software module that is configured to execute one or more tasks. Such tasks may include communication of the autonomous economic agents (AEAs) with each other, processing of information, and so forth. In an example, the autonomous economic agents (AEAs) are configured to employ artificial intelligence (AI) algorithms and machine learning for the execution of the one or more tasks.

Herein, the client-agent (client-AEA) is communicably coupled with the given micro-agent (micro-AEA) that enables operation of the client-agent (client-AEA) within complex economic environments. It will be appreciated that the given micro-agent (micro-AEA) possesses an ability to incorporate external resources and collaborate with other micro-agents (micro-AEAs) to perform tasks that would be difficult for the client-agent (client-AEA) to accomplish alone. Beneficially, the given micro-agent (micro-AEA) promotes secure co-learning of the client-agent (client-AEA). Herein, the client-agent (client-AEA) could be the AEA (such as a software module or a learning software). In another example, the client-agent (client-AEA) includes portable communication device. For example, the client-agent (client-AEA) is at least one of a smartphone, a laptop computer or a tablet computer or a software module in the user device. The system comprises a plurality of modular and extensible software modules configured to operate as the autonomous economic agents (AEAs) meaning that the autonomous economic agents (AEAs) are modular and extensible, thus the autonomous economic agents (AEAs) are self-sufficient entities communicably coupled with the system that could function independently and could be adapted or modified as needed to fit various use cases/circumstances based on their own rules and objectives. The autonomous economic agents (AEAs) are modular, meaning that they are composed of separate parts or units that can be combined together in various manners to achieve a variety of functionalities. The autonomous economic agents (AEAs) are extensible, meaning that their existing functionalities are capable of being extended further by addition of newer modular parts or units. It will be appreciated that when multiple autonomous economic agents (AEAs) work collectively for an application (i.e., use case), different steps of the application are completed by different autonomous economic agents (AEAs). The multiple autonomous economic agents (AEAs) work in consensus to collectively reach a final outcome for achieving a required functionality of said application. Additionally, the autonomous economic agents (AEAs) could be modulated to perform new tasks, respond to changing market conditions, or interact with new environment without disrupting the overall functioning thereof or the system it operates within. This ability to expand and adapt makes autonomous economic agents (AEAs) more versatile and sustainable, thereby making the autonomous economic agents (AEAs) future proof. Herein, the plurality of problem domains may include, but is not limited to, energy, finance, supply chain, governance, manufacturing, mobility, smart cities and internet of things (IoT) applications. Optionally, the micro

The system comprises the decentralised computing network that is configured to implement the software framework. Herein, the software framework encompasses any software abstraction which can have one or more software modules to provide generic and/or specific functionality (or specific functionalities). Optionally, the software framework is an agent framework (i.e., a framework that enables the creation of application-specific AEAs), an open economic framework (OEF) employing autonomous economic agents (AEAs), and the like. In this regard, the software framework is a specific implementation of the decentralised computing network, designed for the purpose of developing the autonomous economic agents (AEAs) (including the micro-agents) and for enabling the autonomous economic agents (AEAs) to interact and transact with each other. The software framework provides the infrastructure and resources for the autonomous economic agents (AEAs) to communicate, negotiate, and exchange value in a secure and transparent manner.

Herein, the open economic framework refers to a computing framework that enables the execution of tasks associated with various autonomous economic agents (AEAs) and the micro-agents (micro-AEAs) within the OEF. Furthermore, the OEF is configured to provide various tools, security protocols, rules, and suchlike for the execution of tasks including, but not limited to, communication, processing of information, and so forth, between different autonomous economic agents (AEAs) and the micro-agents (micro-AEAs) communicably coupled with the OEF. Optionally, the OEF enables the plurality of autonomous economic agents (AEAs) and the plurality of micro-agents (micro-AEAs) to search, discover, and interact with each other. Moreover, the OEF optionally also includes components such as a registry component and a search and discovery component. The registry component could be a database of the plurality of autonomous economic agents (AEAs) and their components such as skills, protocols and connections corresponding to a given service or the functionality. It will be appreciated that each AEA can provide one or more services. The search and discovery component is used to find out one or more autonomous economic agents (AEAs) that match the requested service by the plurality of computing devices. For example, the search and discovery component is accessed by autonomous economic agents (AEAs) to find other autonomous economic agents (AEAs) that offer some specific services.

Optionally, the software framework is an agent framework. An agent framework may be a framework that enables the creation of application-specific autonomous economic agents (AEAs), or a framework designed for developers (person or by artificial intelligence) to develop applications where both agents and a large language model are included in the application. For example, this may be a framework that is designed to simplify creation of applications using Large Language Models (LLMs). In this regard, the software framework is a specific implementation of the decentralised computing network, designed for the purpose of developing the autonomous economic agents (AEAs) and for enabling the autonomous economic agents (AEAs) to interact and transact with each other. The software framework provides the infrastructure and resources for the autonomous economic agents (AEAs) to communicate, negotiate, and exchange value in a secure and transparent manner. Herein, the open economic framework refers to a computing framework that encompasses a discovery and incorporation of new micro-agents (micro-AEAs) by using the Large Language Model (LLM) and enable the execution of tasks associated with the plurality of autonomous economic agents (AEAs) within the software framework. Notably, the framework may provide a standard interface for the plurality of autonomous economic agents (AEAs), and a selection of the plurality of autonomous economic agents (AEAs) to choose from.

Optionally, the decentralised computing network comprises a plurality of computing devices that are communicably coupled to each other, and wherein each of the plurality of computing devices comprises at least one processor, at least one memory device, and a communication interface. In this regard, when in operation, each of the plurality of computing devices can perform as either a client device or a service component. In this regard, the client device is any device that acts as a client for the system, and in particular for autonomous economic agents (AEAs). Examples of the client device include an organization on the cloud seeking a service, an end user with a phone seeking a service or a decentralised autonomous organization (DAO) seeking a service. Optionally, each of the plurality of computing devices can simultaneously perform as the client device and the service component. Furthermore, a computing device that performs as this service component enables the autonomous economic agents (AEAs) to respond to a service request. Furthermore, the decentralised computing network is optionally implemented as a decentralised structured P2P (peer-to-peer) network of devices; alternatively, multi-layer communication networks are employed, wherein communication devices are migrated between the layers depending upon their technical functionality, reliability, peer-review assessment and/or trustworthiness. Specifically, the decentralised structured P2P network represents a decentralised computing environment within a P2P network.

Moreover, the decentralised computing network includes wired and/or wireless communication arrangements (namely “communicating means”) comprising a software component, a hardware component, a network adapter component, or a combination thereof. Furthermore, the communication network may be an individual network, or a collection of individual networks, interconnected with each other and functioning as a single large network. Such individual networks may be wired, wireless, or a combination thereof. In an example, the communication network includes Bluetooth^{®}, Internet of things (IoT), Visible Light Communication (VLC), Near Field Communication (NFC), Local Area Networks (LANs), Wide Area Networks (WANs), Metropolitan Area Networks (MANs), Wireless LANs (WLANs), Wireless WANs (WWANs), Wireless MANs (WMANs), the Internet, telecommunication networks, radio networks, and so forth.

Optionally, the software framework includes the plurality of autonomous economic agents (AEAs) which are communicably interconnected using the decentralised computing network, and wherein the plurality of autonomous economic agents (AEAs) is communicably coupled with the plurality of micro-agents (micro-AEAs). Optionally, the plurality of micro-agents (micro-AEAs) are communicably coupled with each other. Optionally, the plurality of micro-agents (micro-AEAs) provides specialised knowledge and abilities to achieve specific tasks related to the service request. Optionally, the plurality of autonomous economic agents (AEAs) serves as a plurality of worker nodes of the decentralised computing network, for collectively fulfilling a plurality of AEA-based functionalities belonging to the plurality of problem domains. The term “autonomous economic agents (AEA)-based functionalities” as used herein refers to one or more functionalities of the autonomous economic agents (AEAs), that enable the autonomous economic agents (AEAs) to serve the service request. Such functionalities may be, enabling digital payments, generating product recommendations, resolving customer queries, and the like. In this regard, the plurality of autonomous economic agents (AEAs) uses the software framework for collectively fulfilling the service requests belonging to the plurality of problem domains. Optionally, the worker nodes include computing arrangements that are operable to respond to, and process instructions and data therein. The computing arrangements may include, but are not limited to, a microprocessor, a microcontroller, a complex instruction set computing (CISC) microprocessor, a reduced instruction set (RISC) microprocessor, a very long instruction word (VLIW) microprocessor, an artificial intelligence (AI) computing engine based on hierarchical networks of variable-state machines, or any other type of processing circuit. Furthermore, the computing arrangements can be one or more individual processors, processing devices and various elements associated with a processing device that may be shared by other processing devices. Additionally, the computing arrangements are arranged in various architectures for responding to and processing the instructions that drive the system.

In an embodiment, the service request includes at least one of a time needed for providing the service, a price associated with the service, a quality associated with the service, and/or at least one preference associated with the service. For example, the user specifies a parameter (such as, using the graphical user interface associated with a client device) including at least one of: time, price, quality and/or at least one preference that is required by the user in the provided service. In such an instance, the parameter is provided to the client AEA with the generated service request. Furthermore, the client AEA is configured, namely operable, to use the parameter to provide the maximum value to the user. In one example, the service request includes the price associated with the service, such as a minimum and maximum price associated with the service. In such instance, the client AEA enables the user to obtain the service at a price within the minimum and maximum prices specified by the user. Preferably, the client AEA enables the user to obtain the service associated with the minimum price, thereby, enabling maximum value to be provided to the user. In another example, the service request includes a preference associated with the service, such as, to obtain an eco-friendly service. In such an instance, the client AEA enables the user to obtain the service from a service provider that utilizes eco-friendly sources of energy (and/or materials) for providing the service.

Optionally, the service request is associated with an objective. Optionally, the objective defines the purpose or intent behind the service request. Optionally, the objective associated with the service request is represented as one or more vectors, which means that it can be expressed using multiple sets of values or dimensions. Each dimension in the vector represents a specific aspect or characteristic of the objective. Optionally, the one or more vectors are stored and managed in a vector database. Optionally, the Large Language Model (LLM) is used to embed the context of the service request into a vector which is then used to query the vector database to find the list of vectors that have the similarity score above a threshold. Optionally, the Large Language Model (LLM) provides a list of such vectors that are associated with the task and ML model is used to select the best ones that match the criteria for fulfilling the service request. Optionally, an order of tasks associated with the objective of the service request is validated by communication with the Large Language Models (LLM).

Optionally, the given micro-agent (micro-AEA) uses a Large Language model (LLM) to determine the list of steps and sequence of steps to be taken to fulfil the service request. In this regard, the large language model (LLM) is a language model that is considered as a deep learning algorithm trained on a large number of unlabelled datasets. The plurality of micro-agents (micro-AEAs) use the LLM to gather information about the steps to be executed and the sequence of execution of steps. The plurality of micro-agents (micro-AEAs) send the details of requests to be fulfilled and in response, receive the list of steps to be executed. Further, for each micro-agent (micro-AEA), when using the LLM, the external ML module can be a Generative Pre-trained Transformer (GPT) such as a ChatGPT (ChatGPT is a registered trademark) but not limited to. In this regard, when a new service request is received, the LLM provides a recommendation on how the given micro-agent (micro-AEA) can be composed of existing micro-agents (micro-AEAs) to execute the list of recommended steps and the reusability of given micro-agents (micro-AEAs) or of composed given micro-agents (micro-AEAs). The large language model combined with the co-learning software have the effect of generating an optimised list of steps to be executed in a proper sequence for fulfilling the service request. The optimised list of steps provides an enhanced approach in reusability of existing micro-agents (micro-AEAs) and how the given micro-agents (micro-AEAs) can be composed to perform a complex action. The composed micro-agent (micro-AEA) is a combination of two or more micro-agents (micro-AEAs) wherein the two or more micro-agents (micro-AEAs) are combined to perform complex action or to fulfil a complex service request. The reusability and compositions of the plurality of micro-agents (micro-AEAs) reduce the use of computation resources required to fulfil the service request. Moreover, the reusability makes the development and expansion of the system’s functionality time-efficient since it reduces or removes the need for re-programming. Furthermore, the composition and reusability of micro-agents (micro-AEAs) or composed micro-agents (micro-AEAs) provides a way to handle any complex action by using existing protocols without the need to start from scratch thus reducing the use of computational resources.

In an example, if the micro-agent (micro-AEA)1 corresponds to a transportation protocol, the micro-agent (micro-AEA)2 corresponds to a car washing protocol and the micro-agent (micro-AEA)3 corresponds to a car refuelling protocol. Then if the service request is received for a car washing service including a transportation at a given micro-agent (micro-AEA)4, then the micro-agent (micro-AEA)1 and the micro-agent (micro-AEA)2 could be selected and reused. The micro-agent (micro-AEA)4 then could be composed of the micro-agent (micro-AEA)1 and the micro-agent (micro-AEA) 2. In another example if another service request for the car washing with the transportation and the refuelling is received, then the composed micro-agent (micro-AEA)4 and the micro-agent (micro-AEA)3 could be selected and reused.

The software framework includes the domain-independent protocol specification language. The term “domain-independent protocol specification language” as used herein refers to a formal language that enables the definition of protocols for interactions across the plurality of problem domains. In this regard, the domain-independent protocol specification language is used to describe the format, structure, and rules for communication between the plurality of micro-agents (micro-AEAs), between the plurality of micro-agents (micro-AEAs) and the plurality of autonomous economic agents (AEAs), between the plurality of autonomous economic agents (AEAs) and between the plurality of autonomous economic agents (AEAs) and the plurality of computing devices communicably coupled with the decentralised computing network, regardless of the specific application domain or context. It will be appreciated that the domain-independent protocol specification language provides a standardised way of defining protocols that enables interoperability and seamless communication among the plurality of autonomous economic agents (AEAs) in the system, regardless of the domain thereof. Moreover, the domain-independent protocol specification language in the software framework promotes fairness, transparency, and efficiency in the system. Furthermore, the domain-independent protocol specification language enables the system to become scalable for providing multi-domain services.

Optionally, the domain-independent protocol specification language is stored in a form of a set of instructions, in at least one memory device of the decentralised computing network. Optionally, the domain-independent protocol specification language is stored on the at least one memory device in a manner that makes it easily accessible to the plurality of autonomous economic agents (AEAs). Optionally, the at least one memory device may be a physical memory device, such as a hard drive or a flash drive, or a virtual memory device, such as a cloud-based server. Optionally, the domain-independent protocol specification language could also be stored on a cloud-based memory. Optionally, the cloud-based memory is communicably coupled to the decentralised computing network. Furthermore, storing the domain-independent protocol specification language in the form of the set of instructions promotes interoperability, standardization, and reliability in the decentralised computing network, and supports the smooth functioning thereof. It will be appreciated that said set of instructions is well defined and thus could be easily used for defining various types of protocols.

The software framework includes a protocol generator. The term “protocol generator” as used herein refers to a software tool that generates protocol(s) for autonomous economic agents (AEAs) using the domain-independent protocol specification language. The term “protocol” as used herein refers to an implementation of the rules and guidelines described in a protocol specification. In other words, the at least one protocol is one of the critical building blocks and abstractions that define communications of the client-agent (client-AEA). The at least one protocol of the client-agent (client-AEA) defines interactions of the client-agent (client-AEA) with other autonomous economic agents (AEAs) amongst the plurality of autonomous economic agents (AEAs), and with the plurality of computing devices. Moreover, the at least one protocol defines how messages are encoded for a transportation thereof. Optionally, the at least one protocol includes constraints or conditions to ensure that a certain message sequence follows a specific pattern. For example, a “SELL” message must follow a “BUY” message, and a “FINISH” message must follow a “START” message. This means that the client-agent (client-AEA) will only be able to “SELL” or “FINISH” if the appropriate preceding message (BUY or START) has been sent. Additionally, such constraints help to maintain the consistency and integrity of the communication between the plurality of autonomous economic agents (AEAs). It will be appreciated that the protocol generator enables streamlining the development process of the client-agent (client-AEA), reduces the risk of errors in the interactions of the client-agent (client-AEA), and ensures that the at least one protocol is consistent and well-defined. Optionally, the at least one protocol pertains to interactions of the client-agent (client-AEA) across the plurality of problem domains. In this regard, the domain-independent specification language enables the definition of protocols for interactions across the plurality of problem domains. This means that in such a case any protocol could enable the client-agent (client-AEA) to interact for addressing the service requests from the plurality of problem domains.

Herein, the external computing arrangement refers to a collection of computing devices that are used to support the operation of the autonomous economic agents (AEAs) and micro-agents (micro-AEAs) in the system. The external computing arrangement includes a plurality of external computing devices, which are electronic devices capable of performing various computational operations and processing data. Typically, the external computing device includes one or more processing units (such as a central processing unit or graphics processing unit), memory, storage, and communication interfaces (such as Wi-Fi or Ethernet). These components work together to perform various computational tasks, such as running software applications, processing data, and connecting to networks or other devices.

Herein, the term “distributed ledger arrangement” refers to a ledger (such as a database) comprising entries recording operations and/or contracts (preferably smart contracts), with a timestamp. According to the common knowledge in the field of computer science and distributed ledgers, smart contracts may be one or more computer algorithms, or a transaction protocol, where these may be executed via computer programs, respectively intended to automatically execute events or actions according to agreed terms (the contract terms). In this regard, the plurality of external computing devices employs a distributed ledger technology (DLT) technology. Moreover, the distributed ledger arrangement is distributed across the plurality of external computing device. Beneficially, the DLT allows for secure and transparent record-keeping, without the need for intermediaries or centralised authorities. Optionally, the smart contracts may also control, record or document such events or actions according to the terms agreed, for example, agreed on a contract. Optionally, the distributed ledger arrangement is consensually shared and synchronised in a decentralised form across the plurality of autonomous economic agents (AEAs). Optionally, the distributed ledger arrangement refers to a database of entries or blocks of data. It will be appreciated that by using the distributed ledger arrangement, the co-learning module and the plurality of external ML models could be implemented in a decentralised and secure manner. The distributed ledger arrangement ledger ensures that all data and models are tamper-proof and transparent to the plurality of autonomous economic agents (AEAs). This enables the plurality of autonomous economic agents (AEAs) to collaborate effectively and learn from each other, leading to improved performance and better outcomes, while ensuring the integrity and security of the data through cryptographic techniques.

The term “co-learning software module” as used herein refers to a software component that facilitates the collaborative learning of the plurality of autonomous economic agents (AEAs). The co-learning software module enables the plurality of autonomous economic agents (AEAs) to exchange data with each other in order to improve the individual performance thereof. Optionally, the co-learning software module works by integrating the data and knowledge generated by the plurality of autonomous economic agents (AEAs) into the distributed ledger arrangement. The distributed ledger arrangement enables the plurality of autonomous economic agents (AEAs) to learn from each other, thereby leveraging the collective intelligence and expertise of the group to improve individual performance.

The term “external machine learning (ML) models” as used herein refers to computer programs or algorithms that are designed to automatically improve their performance on a specific task or problem by learning from data. The plurality of external ML models is trained on a dataset that includes examples of inputs and their corresponding outputs. The plurality of external ML models then uses the data to identify patterns and relationships between the inputs and outputs. The goal of the plurality of external ML models is to learn a function that can accurately predict the output for new inputs that it has not seen before. Optionally, the plurality of external ML models is selected from at least one of: supervised learning models, unsupervised learning models, semi-supervised learning models, reinforcement learning models, and so forth.

It will be appreciated that the co-learning software module is communicably coupled to the plurality of external ML models to enable the plurality of autonomous economic agents (AEAs) communicably coupled with the plurality of micro-agents (micro-AEAs) in the co-learning system to leverage the knowledge and expertise of the plurality of external ML models to improve the performance thereof. By connecting the co-learning software module to the plurality of external ML models, the given-micro AEA can access a wider range of data, algorithms, and insights that can help them learn more effectively and make better decisions.

Optionally, the plurality of micro-agents (micro-AEAs) may include a context-builder software module that is responsible for building the context necessary to execute the service request. Optionally, the context-builder software module is communicably coupled with a platform which enables creation, testing, development, deployment and management of autonomous economic agents. Optionally, the plurality of micro-agents (micro-AEAs) may include a build executor software module that is specifically designed to handle the composition and execution of the service request within the system. Optionally, the build executor software module ensures that the tasks associated with the service request are organized and arranged according to a predefined sequence or priority. The term “protocol specification” as used herein refers to a set of rules and guidelines that defines a communication between the plurality of autonomous economic agents (AEAs) that are communicably coupled with the plurality of micro-agents (micro-AEAs) in the decentralised computing network. Optionally, the protocol specification defines the communication between the plurality of micro-agents (micro-AEAs) and the plurality of external ML models. The protocol specification is a formal manner in which the at least one protocol is defined. The protocol specification may outline the types of information that may be exchanged between the plurality of micro-agents (micro-AEAs) and the format in which the information should be transmitted. Optionally, the protocol specification may also define the timing of when the information should be exchanged and any error-handling mechanisms that should be in place.

In an embodiment, when the given micro-AEA receives the service request to perform the action from the client-agent (client-AEA), it is configured to generate an invocation of the protocol generator for generating at least one protocol for the protocol specification. In this regard, the given micro-agent (micro-AEA) sends a request to the plurality of external computing devices, asking the plurality of external computing devices to generate a set of rules and procedures that define how the given-micro agent (micro-AEA) will interact with the other micro-agents (micro-AEAs) to complete the action. The protocol generator in the software framework creates the protocol specification based on the specific needs and requirements of the given-micro agent (micro-AEA).

Additionally, the given micro-agent (micro-AEA) is also configured to incorporate a given external ML model from amongst the plurality of external ML models. In this regard, the micro-AEA may use the knowledge and expertise of the external ML model to improve decision-making capabilities thereof, and thereby enhancing the capabilities of the given-AEA communicably coupled therewith.

In an example, when the plurality of computing devices of the decentralised computing network interacts with the plurality of autonomous economic agents (AEAs) for performing the one or more tasks, the given micro-agent (micro-AEA) invokes the protocol generator for the protocol specification. In another example, the given micro-agent (micro-AEA) may invoke the protocol generator for the protocol specification at one or more prespecified time instances. In yet another example, the given micro-agent (micro-AEA) may invoke the protocol generator for the protocol specification when any of the given micro-agent (micro-AEA)′s modular components change.

In another example, the protocol specification in the mobility domain is a set of rules and guidelines that define the interaction between two autonomous economic agents (AEAs) attached to two different autonomous vehicles when exchanging real-time traffic information. Optionally, the protocol specification would likely outline the specific types of information that can be exchanged between the plurality of autonomous economic agents (AEAs), such as traffic congestion levels, accident reports, road closures, and construction updates. Furthermore, the given micro-agent (micro-AEA) is configured to transmit the protocol specification to the plurality of external computing devices. Herein, the term “insight” refers to knowledge or understanding gained through the analysis and processing of information related to the service request and the corresponding micro-agent (micro-AEA). It will be appreciated that the step of generation of the insight provides an improved protocol implementation, help the given micro-agent (micro-AEA) to make better decisions and enhance collaboration amongst the plurality of micro-agents (micro-AEAs). The step of generation of insight includes searching and retrieving of data (such as harvesting data from external sources). The retrieved data is transformed to generate the insight. The plurality of external computing devices is configured to receive the invocation for generating the at least one protocol for the protocol specification from the given micro-agent (micro-AEA). The plurality of external computing device is configured to generate the insight corresponding to the action, using the given external ML model and/or the co-learning software module. Optionally, the plurality of external computing device uses the given external ML model to analyse and process data related to the service request and the given micro-agent (micro-AEA). Optionally, the given external ML model identify patterns and correlations in the data that can form the generation of the insight. For example, the given external ML model could analyse historical data on similar service requests and identify common patterns or trends that can inform the decision-making process of the plurality of external computing device.

Optionally, the plurality of external computing device uses the co-learning software module to facilitate collaboration and knowledge sharing between the given micro-agent (micro-AEA) and the other micro-agents (micro-AEAs). Optionally, the co-learning software module can capture, and process information related to the actions being performed by the plurality of micro-agents (micro-AEAs) and use that information to generate the insights. For example, the co-learning software module could analyse the data on the performance of the given micro-agent (micro-AEA) in fulfilling the service request and identify areas where improvements are required. Furthermore, the plurality of external computing devices is configured to transmit the insight to the given micro-agent (micro-AEA).

Optionally, the insight comprises at least one of:
a requirement to generate the implementation of the at least one protocol corresponding to the protocol specification, to fulfil the service request;
a possibility to reuse at least one of: one or more existing protocols for the given micro-agent (micro-AEA), one or more existing skills of the given micro-agent (micro-AEA), one or more existing connections supported by the given micro-agent (micro-AEA); and
a requirement to generate at least one of: a new protocol, a new connection, a new skill.

In this regard, the insight could be a suggestion that the given micro-agent (micro-AEA) does not have an existing protocol that can fulfil the service request and that a new protocol is required to be generated to provide the necessary functionality. For example, if the given micro-agent (micro-AEA) receives the service request to perform a specific action, but the given micro-agent (micro-AEA) does not have an existing protocol to carry out that action, the plurality of external computing devices can generate the insight that a new protocol needs to be developed.

The term “skills” as used herein refers to specialised software modules that provide various capabilities to the given micro-agent (micro-AEA). In other words, the skills are behavioural capabilities of the given micro-agent (micro-AEA) that enables the given micro-agent (micro-AEA) to fulfil the service requests (for example in the plurality of problem domains). The term “connections” as used herein refers to at least one of: a connection between the given micro-agent (micro-AEA) and another micro-agent (micro-AEA), a connection between the given micro-agent (micro-AEA) and the client-agent (client-AEA), and a connection between the given micro-agent (micro-AEA) and the plurality of external computing devices. Herein, the one or more protocols, the one or more skills, and the one or more connections are building blocks or core elements of the given micro-agent (micro-AEA) that define the decision-making process and functionality thereof.

Optionally, the insight includes the possibility to reuse one or more existing protocols for the given micro-agent (micro-AEA). For example, if the given micro-agent (micro-AEA) has previously implemented a protocol to request data from an external data source. Now, a service request comes in that requires the given micro-agent (micro-AEA) to perform a similar action, but with a different data source. In this case, the plurality of external computing devices can analyse the service request and generate an insight that suggests the given micro-agent (micro-AEA) to reuse the existing protocol, but with a modification to the data source address. By reusing the existing protocol, the given micro-agent (micro-AEA) can avoid the need to develop the new protocol from scratch, which can save time and resources. Moreover, the said insight maintains consistency and coherence in the given micro-agent (micro-AEA)′s protocols, as it can build upon existing ones and avoid redundancies.

Optionally, the insight includes the possibility to reuse the one or more existing skills of the given micro-agent (micro-AEA). In an embodiment, the given micro-agent (micro-AEA) could get the insight of using its existing negotiation skill to fulfil a new service request. Optionally, the insight includes the possibility to reuse one or more existing connections supported by the given micro-agent (micro-AEA). For example, the given micro-agent (micro-AEA) has previously established a connection with an external database to store and retrieve data. Now, another service request comes in that requires the given micro-agent (micro-AEA) to communicate with another external application. In such a case, the plurality of external computing devices could analyse the service request and generate the insight that suggests the given micro-agent (micro-AEA) can reuse the existing connection to communicate with the new application. By reusing the existing connection, the given micro-agent (micro-AEA) can avoid the need to establish a new connection, which can save time and resources. Beneficially, said insight helps maintain consistency and coherence in the given micro-agent (micro-AEA)′s connections, as it can build upon existing ones and avoid redundancies.

Optionally, the insight includes the requirement to generate at least one of: a new protocol, a new connection, a new skill. In this regard, the insight suggests that the given micro-agent (micro-AEA) needs to develop new resources or capabilities to fulfil the service request, and that existing resources are not sufficient to meet the requirements. For example, the given micro-agent (micro-AEA) receives the service request to perform a new and unique action that it has never done before, the plurality of external computing devices can generate the insight that a new protocol, connection, or skill needs to be developed to fulfil the request.

The given micro-agent (micro-AEA) is configured to receive the insight from the plurality of external computing devices. The given micro-agent (micro-AEA) is configured to transmit metadata to the plurality of external computing devices. Herein, the metadata corresponds to the protocol specification and the received insight. Optionally, the metadata refers to any information that is necessary or useful for the given action to be performed.

Optionally, the metadata comprises at least one of: a technological setup of the given micro-agent (micro-AEA), one or more protocols for the given micro-agent (micro-AEA), one or more skills of the given micro-agent (micro-AEA), one or more connections supported by the given micro-agent (micro-AEA), the service request received by the given micro-agent (micro-AEA). It will be appreciated that such information is beneficially included in the metadata since it allows for more precise and efficient processing of the service request by the given micro-agent (micro-AEA). Moreover, by limiting the scope of the metadata to the technological setup, the one or more protocols, the one or more skills, the one or more connections, and the service request, the given micro-agent (micro-AEA) could focus on the specific details that are necessary to complete the requested action, without being burdened by unnecessary or irrelevant data. This can help to reduce processing time and improve overall performance, as the given micro-agent (micro-AEA) can quickly and accurately identify the necessary resources and the one or more protocols to complete the task at hand. Herein, the technological setup of the given micro-agent (micro-AEA) refers to a hardware and a software configuration of the given micro-agent (micro-AEA). For example, the technological setup could include information such as an operating system, a programming language, libraries, and other tools that are used to develop and run the given micro-agent (micro-AEA). It will be appreciated that such data is relevant if the action requires a certain technology setup to be in place.

Herein, the one or more protocols for the given micro-agent (micro-AEA) refer to the communication protocols that the given micro-agent (micro-AEA) supports. It will be appreciated that the metadata here could include the specific protocol that needs to be used to complete the action, as well as any relevant parameters or configurations associated with that protocol. Optionally, the metadata includes information of the one or more skills of the given micro-agent (micro-AEA) that are required to complete the action. Optionally, the one or more skills refer to the capabilities or competencies of the given micro-agent (micro-AEA). For example, the one or more skills could be natural language processing, image recognition, or data analysis.

Optionally, the metadata includes information of the one or more connections supported by the given micro-agent (micro-AEA) that needs to be used to complete the action, as well as any relevant parameters or configurations associated with that connection. Optionally, the metadata includes information about the specific service request that triggered the action. Moreover, the metadata here could include information such as the content of the service request, the user or system that initiated the service request, and any other relevant contextual information.

Optionally, the technological setup of the given micro-agent (micro-AEA) comprises at least one of: a programming language in which the given micro-agent (micro-AEA) is created, an operating system of the given micro-agent (micro-AEA), a library available to the given micro-agent (micro-AEA), an amount of computational resources available with the given micro-agent (micro-AEA), a platform that the given micro-agent (micro-AEA) runs on.

The “technological setup” of the given micro-agent (micro-AEA) refers to specific technologies and resources that are available to the given micro-agent (micro-AEA) within the system. The technological set up includes the programming languages used by the given micro-agent (micro-AEA). Examples of the programming language include Python, Java, C++, and so forth. The technological set up includes the operating system of the given micro-agent (micro-AEA). Examples of the operating system include Windows, MacOS, Linux, and so forth. The technological set up includes the library available to the given micro-agent (micro-AEA). Examples of the library TensorFlow, NumPy, OpenCV, and so forth. The technological set up includes the number of computational resources available with the given micro-agent (micro-AEA). Examples of the computational resources include a processor type, a random access memory, a storage device, and so forth. The technological set up includes the platform that the given micro-agent (micro-AEA) runs on. Examples of the platform include Cloud, Edge, Mainframe, and so forth. It will be appreciated that the technological setup may be used in some implementations to determine how the at least one protocol should be implemented for the client-agent (client-AEA). The technical effect of the aforementioned factors of the technological setup of the given micro-agent (micro-AEA) could impact its functionality, performance, and compatibility with the other. It is important to consider the aforementioned factors when designing and developing the given micro-agent (micro-AEA) to ensure optimal performance and compatibility. For example, if the technological setup of the client-agent (client-AEA) includes a limited amount of memory, the protocol generator may produce an implementation of the protocol that is optimised for low-memory usage. In another example, if the agent’s technological setup includes support for a specific programming language, the protocol generator may produce an implementation of the protocol in that specific programming language.

Optionally, the metadata refers to data that describes or provides information about other data. Optionally, the metadata of the given micro-agent (micro-AEA) could include information such as the given micro-agent (micro-AEA)′s capabilities, protocols, connections, and other relevant properties.

In an example, when the plurality of external computing devices generates the insight based on the action requested, it may analyse the metadata of the given micro-agent (micro-AEA) to determine what metadata is necessary. For example, if the action involves sending a message to an external system using a particular protocol, the metadata might include the protocol parameters and connection details, which can be obtained from the given micro-agent (micro-AEA)′s metadata. The plurality of external computing devices could then use the metadata to complete the action. Furthermore, the given micro-agent (micro-AEA) is configured to transmit the metadata corresponding to the protocol specification and the received insight to the plurality of external computing devices. Herein, the term “inference” refers to a conclusion or a prediction that is obtained based on a set of observations or data. In this regard, the plurality of external computing devices uses the given external ML model and/or the co-learning software module to make a prediction or decision by applying the insight and the metadata thereon, thereby generating the inference. It will be appreciated that the step of generating the inferences based on the insights and the metadata, allows the system to continuously improve and refine the at least one protocols used by the client-agent (client-AEA), resulting in more efficient and effective co-learning among the plurality of micro-agents (micro-AEAs). Moreover, the plurality of external computing devices uses the external ML model and/or co-learning software module to analyse the metadata and the insight corresponding to the protocol specification. Based on the analysis, the plurality of external computing devices generates the inference that is then sent to the given micro-agent (micro-AEA). Furthermore, the plurality of external computing devices is configured to transmit the inference to the given micro-agent (micro-AEA).

Optionally, one approach to circumventing the limitations of public distributed ledger arrangements are secondary distributed ledgers (namely, side-chains). These are distinct ledger networks that communicate with the public distributed ledger arrangement. This communication with the main ledger provides two principal benefits. The first is that digital tokens, also known as cryptocurrency, that are represented on the main ledger can be used to incentivize activities on the side-chain. This enables payments for contributing positively towards collective learning tasks, slashing of staked funds for malicious acts and for these behaviours to be used to establish reputations for different actors in the decentralized computing network. The other benefit of running a side-chain is that the security and immutability of the side-chain can be guaranteed by recording some events that occur there, such as the production of blocks, to the main chain.

Optionally, the present disclosure further employs homomorphic encryption (HE) that are a diverse family of cryptographic techniques that allow mathematical operations to be performed on encrypted data without revealing anything about the underlying data itself to the party that performs the calculations. The present disclosure provides two different modes for collective learning. The first mode involves the use of homomorphic encryption (HE) techniques and an on-chain consensus algorithm to pre-cluster the worker nodes into groups using pre-trained (and potentially simplified) versions of their local models. In all of these examples, these systems self-organise without requiring coordination by a trusted central authority.

Optionally, the present disclosure describes extensions to ensure privacy. In this regard, the system aggregates updates from multiple validators using secret sharing techniques. Optionally, the at least one protocol can be extended to this type of setting by using decentralized random beacons (DRBs) to elect a subset of the committee to produce the next block.

Optionally, the at least one protocol may be vulnerable to the model owners either altering their model when queried by different validators or for them to withhold predictions. It is similarly possible for a data provider to either report an incorrect calculation of the error or also submit different data sets to different models. Both of these types of attack can be mitigated by doing the homomorphic encryption in a multi-party computation (MPC) setting where either the data or models are shared between multiple parties in encrypted form, and the error calculation itself is computed using the homomorphic encryption. In this scenario, attacks can only be carried out successfully if there is collusion between several parties. The security provided by the decentralized random beacon (DRB) ensures that the probability of this attack succeeding decays exponentially with the number of parties that share the data/model. Unlike the other protocols, mentioned above, this scheme does not require that the validators classify the data using homogeneous models (e.g., neural networks with identical topologies). This protocol can therefore be used to also select model topologies for subsequent stages of the learning process. Furthermore, the configuration of learners and model builders but involving multi-party computation (MPC) can be used directly to train multi-task learning approaches. Optionally, rather than using a different distributed ledger arrangement for training the micro-agent (micro-AEA), an alternative would be to use classical multi-task learning to train the external machine learning models for each task with additional modifications to account for the task dependencies.

The given protocol generator is configured to generate the implementation of the protocol specification for the client-agent (client-AEA). In this regard, the given protocol generator uses the inference and the domain-independent protocol specification language.

Herein, the implementation of the at least one protocol refers to a combination of code, data structures, and algorithms that define how the client-agent (client-AEA) communicates with the other plurality of autonomous economic agents (AEAs) and the plurality of computing devices, process incoming service requests, and executes specific actions based on the protocol specification defined in the at least one protocol. Optionally, the implementation is a working version of the at least one protocol that can be integrated into the client-agent (client-AEA) and put into operation. In other words, the implementation of the at least one protocol is the outcome of the process of creating the code or configuration files that follow the rules and conventions defined by the protocol specification.

Optionally, the implementation of the at least one protocol for the client-agent (client-AEA) defines at least one dialogue-based bilateral interaction protocol supporting arbitrary agent-based interactions of the client-agent (client-AEA). In this regard, the implementation of the at least one protocol for the client-agent (client-AEA) enables the client-agent (client-AEA) to engage in bilateral interactions with the plurality of autonomous economic agents (AEAs) in a defined and structured manner. The term “dialogue-based bilateral interaction protocol” refers to a set of rules and procedures that governs the communication and exchange of information by autonomous economic agents (AEAs) in a conversational or a dialogue-based manner. It will be appreciated that such dialogue-based bilateral interaction protocol emulates the human to human communication, thereby enhancing the capabilities of the system. Herein, the at least one protocol allows for arbitrary interactions of the autonomous economic agents (AEAs), meaning that the type and content of the interactions are not restricted or predetermined. For example, one such protocol could be a negotiation protocol, where two autonomous economic agents (AEAs) engage in a dialogue to agree on terms for a transaction. Optionally, the at least one protocol may define the steps involved in the negotiation process, such as the exchange of information, the making of offers and counter-offers, and the final agreement. It will be appreciated that the implementation of the dialogue-based bilateral interaction protocol for the client-agent (client-AEA) enables the client-agent (client-AEA) to engage in flexible and dynamic interactions with the other plurality of autonomous economic agents (AEAs) and computing devices, allowing for a wide range of economic transactions and activities to take place.

Optionally, the inference comprises at least one of:
a recommendation of how to produce the implementation of the at least one protocol corresponding to the protocol specification, to fulfil the service request;
a recommendation of how to combine at least one of: one or more existing protocols for the given micro-agent (micro-AEA), one or more existing skills of the given micro-agent (micro-AEA), one or more existing connections supported by the given micro-agent (micro-AEA), to create a new functionality for the clientagent (client-AEA) corresponding to the service request; and
a recommendation of how to generate at least one of: a new protocol, a new connection, a new skill, to fulfil the service request.

In this regard, the inference generated by the plurality of external computing devices could be in a form of a recommendation. Optionally, the recommendation is in such as a format that is readable by the given micro-agent (micro-AEA) and the client-agent (client-AEA). Optionally, the recommendation could include guidance on how to modify the at least one protocol to develop the new at least one protocol corresponding to the protocol specification to fulfil the service request. For example, the given micro-agent (micro-AEA) receives the service request of booking a flight and the given micro-agent (micro-AEA) does not have the at least one protocol to handle the flight booking. In such a case, the inference generated by the plurality of external computing devices could recommend creating at least one new protocol that includes steps to search for the flights, select the flight, and make the booking.

Optionally, the recommendation could include guidance on how to combine at least one of the one or more protocols (for a single micro-agent (micro-AEA) or for multiple micro-agents (micro-AEAs)), the one or more skills (of a single AEA or of multiple micro-agents (micro-AEAs)), the one or more connections (supported by a single AEA or supported by multiple micro-agents (micro-AEAs)). It will be appreciated that the micro-agent (micro-AEA) whose protocols are used in such combining may be different from the micro-agent (micro-AEA) whose skills are used in such combining and from the micro-agent (micro-AEA) whose connections are used in such combining. In an example, the software framework includes ten micro-agents (micro-AEAs) Z1 to Z10. For a given micro-agent (micro-AEA) Z2 there may be combined a total of four protocols for micro-agents (micro-AEAs) Z1 and Z3, a total of three skills of micro-agents (micro-AEAs) Z1, Z4, and Z5, and a total of two connections supported by Z1. In another example, the given micro-agent (micro-AEA) receives the service request of ordering food from a restaurant, and the given micro-AEA has the existing one or more protocols for searching restaurants and making reservations but does not have the one or more protocols for ordering the food. In such a case, the inference generated by the plurality of external computing devices could be the recommendation for combining the existing one or more protocols for the restaurant search and the reservation with the new protocol for ordering food to create the new functionality that can fulfil the service request. In another example, a skill A encapsulating a simple logic of looking up real-time data on external data sources, and a skill B that places a buy/sell order on an item in an online marketplace, could be combined together in a skill C to look up the price of a certain goods (using skill A), and place a buy/sell order on a specific marketplace (using skill B) if the price changes more than a certain threshold (logic exclusive to skill C).

Optionally, the recommendation could include guidance on how to develop at least one of: a new protocol, a new connection, or a new skill to fulfil the service request. For example, the given micro-agent (micro-AEA) receives the service request to book a hotel room and the given micro-agent (micro-AEA) does not have the one or more protocol to handle hotel bookings. In such a case, the inference generated by the plurality of external computing devices could recommend creating a new protocol for hotel bookings that includes steps to search for hotels, select a hotel, and make a booking.

Optionally, the given micro-agent (micro-AEA) is configured to execute the generated at least one protocol such that the action associated with the service request, received by the client-agent (client-AEA), is executed. In this regard, said execution of the generated at least one protocol is optional and may require an approval from the client-agent (client-AEA). Optionally, the approval process may be manual, where the client-agent (client-AEA) reviews and approves the service request before the given micro-agent (micro-AEA) executes the generated at least one protocol. Alternatively, the approval process may be automated, where the client-agent (client-AEA) has preconfigured conditions that trigger automatic approval for certain types of service requests. For example, the client-agent (client-AEA) may set a condition that automatically approves any train ticket request from Cambridge to London during business hours if the service request is for work purposes. In this case, the given micro-agent (micro-AEA) would receive the service request and execute the generated at least one protocol without requiring any further approval from the client-agent (client-AEA). It will be appreciated that the given micro-agent (micro-AEA) is flexible and autonomous and is capable of executing protocols and performing actions on behalf of the client-agent (client-AEA), while also allowing for human intervention or pre-set conditions to ensure appropriate decision-making.

Optionally, when the co-learning software module is configured to generate the insight corresponding to the action, the co-learning software module is configured to engage with the plurality of external machine learning (ML) models for receiving learnings of the plurality of external machine learning (ML)models, wherein the engagement of the co-learning software module with the plurality of external machine learning (ML) models occurs without sharing metadata of any external machine learning (ML) model with other external machine learning (ML) models.

In this regard, when the co-learning software module is configured to generate the insight corresponding to the action, the co-learning software module engages with the plurality of external ML models to collaborate and generate the insights without sharing their local data directly. Instead, the co-learning software module engages with the plurality of external ML models to receive learnings therefrom, without sharing their metadata with each other. Beneficially, by not sharing data directly, the co-learning software module addresses privacy concerns that may arise from sharing sensitive information between the plurality of external ML models. It will be appreciated that by engaging with the plurality of external ML models, the co-learning software module could better handle failures or malicious behaviour from the plurality of external ML models.

Optionally, when the co-learning software module is configured to generate the inference related at least to the protocol specification, the co-learning software module is configured to analyse the metadata and the learnings of the plurality of external machine learning (ML) models in respect of each other and generate the inference based on said analysis.

In this regard, the co-learning software module is configured to generate the inference related to at least the protocol specification. Moreover, when generating the inference, the co-learning software module is configured to analyse the metadata and the learnings of the plurality of external ML models in respect of each other, and generate the inference based on the analysis. Optionally, the learnings refer to the knowledge and the insight that have been learned by the plurality of external ML models. Optionally, each of the plurality of external ML models has been trained on a different dataset and may have learned different patterns and features. Optionally, the analysis could be done using the data processing algorithm or the machine learning algorithm. Optionally, the analysis involves comparing the learned patterns and features across the plurality of external ML models and identifying the commonalities and differences. Furthermore, based on the analysis of the metadata and the learnings, the co-learning software module generates the inference related to at least the protocol specification. It will be appreciated that the co-learning software module generates more accurate and robust inferences by leveraging the knowledge and insights learned from the plurality of external ML models.

Optionally, the given external machine learning (ML) model is communicably coupled to at least one other external machine learning (ML) model of a second micro-agent (micro-AEA), and wherein when the given external machine learning (ML) model is configured to generate the insight corresponding to the action, the given external machine learning (ML) model is configured to engage with the at least one other external machine learning (ML) model for receiving learnings of the at least one other external machine learning (ML) model, wherein the engagement of the given external machine learning (ML) model with the at least one other external machine learning (ML) model occurs without sharing metadata of the at least one other external machine learning (ML) model with the given external machine learning (ML) model.

In this regard, when the given external ML model is configured to generate the insight corresponding to the action, it is configured to engage with the at least one other external ML model for receiving the learnings of the other external ML model. This means that the given external ML model could learn from the other external ML model without relying on a central party or a central node to manage the learning process. Furthermore, the engagement of the given external ML model with the at least one other external ML model occurs without sharing metadata of the other external ML model with the given external ML model. It will be appreciated that said feature protects the privacy and security of the other external ML model and its communicably coupled micro-agent (micro-AEA).

Optionally, when the given external machine learning (ML) model is configured to generate the inference related at least to the protocol specification, the given external machine learning (ML) model is configured to analyse the metadata, its learnings, and the learnings of the at least one other external machine learning (ML) model in respect of each other, and generate the inference based on said analysis.

In this regard, when the given external ML model is configured to generate the inference related to the protocol specification, it means that it is making a prediction or decision based on the data and the protocol specification. Optionally, the metadata is analysed using the statistical analysis, the machine learning algorithms, data visualisation, and so forth. For example, the protocol specification might include rules or guidelines for how the data should be analysed, and the given external ML model is using its machine learning algorithms to generate an output based on these rules. Moreover, to make a more accurate and robust inference, the given external ML model is configured to analyse not just its own learnings, but also the learnings of the at least one other external ML model. This means that the given external ML model takes into account the insights and perspectives of the at least one other external ML model. By analysing the learnings in respect of each other, the given external ML model can gain a more comprehensive and nuanced understanding of the data and generate a more accurate inference.

In another example, if a user books a meeting in his calendar application of the user device. The calendar application in the user device is the source of the service request for the client-agent (client-AEA). The client-agent (client-AEA) automatically sends the service request related to the meeting. If the meeting is in London, the service request is related to booking the meeting place, arranging the transportation, confirming the other party about the meeting place. The given micro-agent (micro-AEA) is then configured to generate the invocation upon receiving the service request and to send the protocol specification to the plurality of external computing devices. The external computing device is configured to send the insights, for example insights related to the costs or location or a quality measure (for example space) associated with the booking of meeting place and/or associated with arranging the accommodation. The given micro-agent (micro-AEA) is then configured to send the metadata such as time slot, minimum and maximum cost, preference for the meeting place such as hotel or a café. The plurality of external computing devices is configured to generate and send the inference to the given micro-agent (micro-AEA), the inference is related to the best place for the meeting and a transportation means selected in accordance with the metadata provided by using the co-learning software. In response, the given micro-agent (micro-AEA) is configured to execute the protocol generator and autonomously books the meeting room and transportation which may include train tickets or a cab and informs the other party about the meeting place and time.

Optionally, the client-agent (client-AEA) has the ability to compose a new micro-agent (micro-AEA) from the existing micro-agents (micro-AEAs) for performing complex service requests. Optionally, each micro-agent (micro-AEA) could receive the inference from the corresponding external machine learning (ML) model, meaning that the micro-agents (micro-AEAs) could receive multiple inferences for the complex service request. Additionally, the composed micro-agent (micro-AEA) may be able to receive a combined single inference. It will be appreciated that the composed micro-agent (micro-AEA) may be able to process and act on information more efficiently than individual micro-agents (micro-AEAs).

The present disclosure also relates to the method as described above. Various embodiments and variants disclosed above apply mutatis mutandis to the method.

Optionally, the method further comprises executing the generated at least one protocol using the given micro-agent such that the action associated with the service request, received by the client- agent, is executed.

Optionally, when the co-learning software module implements the step of generating the insight corresponding to the action, the method comprises engaging with the plurality of external machine learning (ML) models for receiving learnings of the plurality of external machine learning (ML) models, wherein the engagement of the co-learning software module with the plurality of external machine learning (ML) models occurs without sharing metadata of any external machine learning (ML) model with other external machine learning (ML) models.

Optionally, the co-learning software module implements the step of generating the inference related at least to the protocol specification, and wherein the method comprises analysing the metadata and the learnings of the plurality of external machine learning (ML) models in respect of each other, and generating the inference based on said analysis.

Optionally, the given external machine learning (ML) model is communicably coupled to at least one other external machine learning (ML) model of a second micro-agent (micro-AEA), and wherein when the given external machine learning (ML) model implements the step of generating the insight corresponding to the action, the method comprises engaging the given external machine learning (ML) model with the at least one other external machine learning (ML) model for receiving learnings of the at least one other external machine learning (ML) model, wherein the engagement of the given external machine learning (ML) model with the at least one other external machine learning (ML) model occurs without sharing metadata of the at least one other external machine learning (ML) model with the given external machine learning (ML) model.

Optionally, the given external machine learning (ML) model implements the step of generating the inference related at least to the protocol specification, and wherein the method comprises analysing the metadata, learnings of the given external machine learning (ML) model, and the learnings of the at least one other external machine learning (ML) model in respect of each other, and generating the inference based on said analysis.

Optionally, the insight comprises at least one of:
a requirement to generate the implementation of the at least one protocol corresponding to the protocol specification, to fulfil the service request;
a possibility to reuse at least one of: one or more existing protocols for the given micro-agent (micro-AEA), one or more existing skills of the given micro-agent (micro-AEA), one or more existing connections supported by the given micro-agent (micro-AEA); and
a requirement to generate at least one of: a new protocol, a new connection, a new skill.

Optionally, the metadata pertaining to the action comprises at least one of: a technological setup of the given micro-agent (micro-AEA), one or more protocols for the given micro-agent (micro-AEA), one or more skills of the given micro-agent (micro-AEA), one or more connections supported by the given micro-agent (micro-AEA), the service request received by the given micro-agent (micro-AEA).

Optionally, the inference comprises at least one of:
a recommendation of how to produce the implementation of the at least one protocol corresponding to the protocol specification, to fulfil the service request;
a recommendation of how to combine at least one of: one or more existing protocols for the given micro-agent (micro-AEA), one or more existing skills of the given micro-agent (micro-AEA), one or more existing connections supported by the given micro-agent (micro-AEA), to create a new functionality for the clientagent (client-AEA) corresponding to the service request; and
a recommendation of how to generate at least one of: a new protocol, a new connection, a new skill, to fulfil the service request.

### DETAILED DESCRIPTION OF THE DRAWINGS

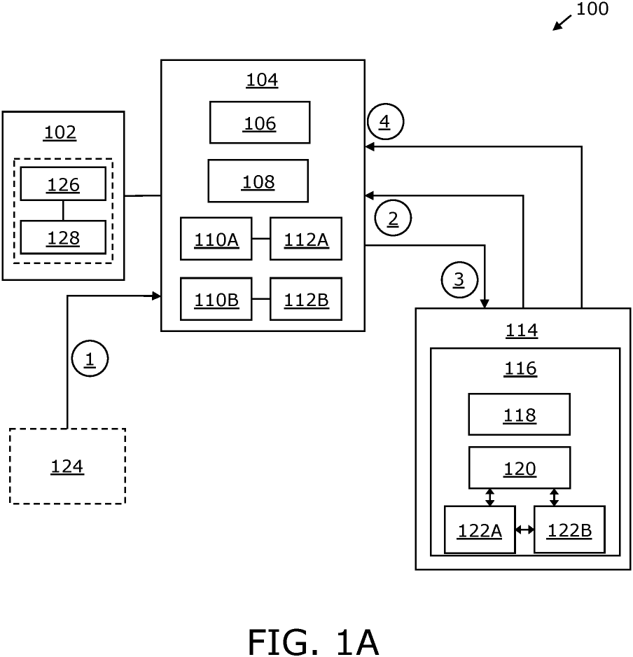

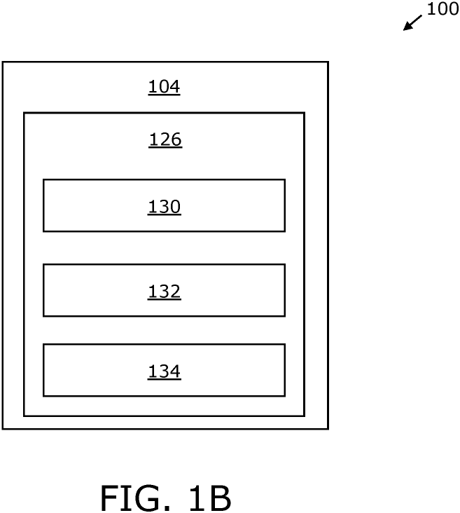

Referring to FIG. 1A, there is shown a block diagram illustrating a system 100 that, in operation, enables application of autonomous economic agents (AEAs) across a plurality of problem domains, in accordance with an embodiment of the present disclosure. As shown, the system 100 comprises a decentralised computing network 102 that is configured to implement a software framework 104, wherein the software framework 104 includes a domain-independent protocol specification language 106, a protocol generator 108 and a plurality of modular and extensible software modules configured to operate as a plurality of autonomous economic agents (AEAs) 110A and 110B (hereinafter collectively referred as 110, for the sake of simplicity), and wherein the plurality of autonomous economic agents (AEAs) 110 are communicably coupled with a plurality of micro-agents (micro-AEAs) 112A and 112B (hereinafter collectively referred as 112, for the sake of simplicity). Moreover, the system 100 comprises an external computing arrangement 114 comprising a plurality of external computing devices such as 116. Moreover, optionally, the plurality of external computing devices 116 is part of a distributed ledger arrangement 118 upon which a co-learning software module 120 and a plurality of external machine learning (ML) models 122A and 122B (hereinafter collectively referred as 122, for the sake of simplicity) are implemented, wherein the co-learning software module 120 is communicably coupled to the plurality of external machine learning (ML) models such as 122. Moreover, a given micro-agent (micro-AEA) such as 112A is configured to generate an invocation of the protocol generator 108 for generating at least one protocol for a protocol specification, upon receiving a service request (depicted as step 1 in the figure) to perform an action, and to incorporate a given external machine learning (ML) model such as 122A from amongst the plurality of external machine learning (ML) models 122 with its corresponding client- agent such as 110A. Optionally, the service request is sent by a user device 124. The given micro-agent (micro-AEA) such as 110A is configured to transmit the protocol specification to the plurality of external computing devices 116. The plurality of external computing devices 116 is configured to receive, from the given micro-agent (micro-AEA) such as 110A, the invocation for generating the at least one protocol for the protocol specification. Furthermore, the plurality of external computing devices 116 is configured to generate an insight corresponding to the action, using the given external machine learning (ML) model such as 122A and/or the co-learning software module 120 and to transmit the insight to the given micro-agent (micro-AEA) 112A.

As shown, the given micro-agent 112A is configured to receive the insight (depicted as step 2 in the figure) from the plurality of external computing devices 116 and to transmit metadata (depicted as step 3 in the figure) corresponding to the protocol specification and the received insight to the plurality of external computing devices 116. Furthermore, the plurality of external computing devices 116 is configured to generate an inference (depicted as step 4 in the figure) by applying the insight and the metadata to the given external machine learning (ML) model such as 122A and/or the co-learning software module 120, and to transmit the inference to the given micro-agent (micro-AEA) such as 112A. The given protocol generator 108 is configured to produce an implementation of the at least one protocol to implement the protocol specification using the inference and the domain-independent protocol specification language 106. Optionally, the decentralised computing network 104 comprises a plurality of computing devices 126 and 128 that are communicably coupled to each other.

In an example, each user of the user device 124 is provided with the client-agent 110A. Such client agent 110A is configured, namely operable, to automatically send the service request and provide the user with the maximum value when using the user device 124 to obtain the service. In one example, the user device 124 includes an electric vehicle and the service request includes an autonomous request by the client-agent (client-AEA) 110A of electric vehicle to recharge the battery of the electric vehicle. The micro- AEA 112A for the client-agent (client-AEA) 110A is configured to generate an invocation upon receiving the service request and to send the protocol specification to the plurality of external computing devices such as 116. The plurality of external computing devices 116 is configured to send an insight using the co-learning software module 120. The insight is in the form of average costs for recharging the vehicle. The micro-agent (micro-AEA) 112A is then configured to send the metadata such as time slot, price, battery parameters. The metadata may include other parameters such as quality of service and user preferences such as eco-friendly sources of energy but not limited to. The plurality of external computing devices 116 is configured to generate and send the inference to the micro-agent (micro-AEA) 112A. For the given example, the inference is related to the information of the charging station that fulfils the requirements based on the metadata sent by the micro-agent (micro-AEA) 112A. In response, the micro-agent (micro-AEA) 112A is configured to execute the protocol generator 108 and autonomously books the time slot for the said charging station.

Referring to FIG. 1B, there is shown an architecture of the decentralised computing network 104 of the system of FIG. 1A, in accordance with an embodiment of the present disclosure. As shown, the decentralised computing network 104 comprises a computing device 126 that comprises at least one processor 130, at least one memory device 132, and a communication interface 134. It will be appreciated that the computing device 128 can also have a similar architecture as the computing device 126.

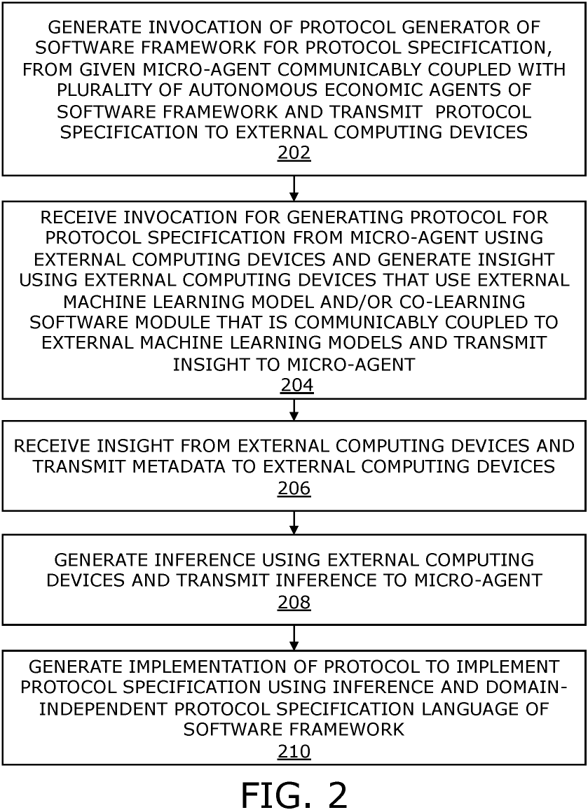

Referring to FIG. 2, shown is a flowchart depicting steps of a method for enabling application of autonomous economic agents (AEAs) across a plurality of problem domains, in accordance with an embodiment of the present disclosure. At step 202, an invocation of a protocol generator of the software framework for a protocol specification is generated, from a given micro-agent (micro-AEA) communicably coupled with a plurality of modular and extensible software modules configured to operate as a plurality of autonomous economic agents (AEAs) of a software framework, upon receiving a service request to perform an action from a client- agent (Client-AEA), and incorporating a given external machine learning (ML) model from amongst a plurality of external machine learning (ML) models and transmitting the protocol specification to the plurality of external computing devices. At step 204, the invocation for generating the at least one protocol for the protocol specification from the given micro-agent (micro-AEA) is received using the plurality of external computing devices and an insight corresponding to the action is generated using the plurality of external computing devices that uses the given external machine learning (ML) model and/or a co-learning software module that is communicably coupled to the plurality of external machine learning (ML) models, and the insight is transmitted to the given micro-agent (micro-AEA), wherein the given external machine learning (ML) model and the co-learning software module are implemented upon a distributed ledger arrangement. At step 206, the insight from the plurality of external computing devices is received and the metadata corresponding to the protocol specification and the received insight is transmitted to the plurality of external computing devices. At step 208, an inference is generated using the plurality of external computing devices, upon receiving the metadata from the given micro-agent (micro-AEA), by applying the insight and the metadata to the given external machine learning (ML) model and/or the co-learning software module and transmitting the inference to the given micro-agent (micro-AEA). At step 210, an implementation of the at least one protocol is generated to implement the protocol specification using the inference and a domain-independent protocol specification language.

The aforementioned steps are only illustrative and other alternatives can also be provided where one or more steps are added, one or more steps are removed, or one or more steps are provided in a different sequence without departing from the scope of the claims herein.

Modifications to embodiments of the present disclosure described in the foregoing are possible without departing from the scope of the present disclosure as defined by the accompanying claims. Expressions such as “including” “comprising” “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

What is claimed is:

1. A system that, in operation, enables application of autonomous economic agents (AEAs) across a plurality of problem domains, the system comprising:
a decentralised computing network configured to implement a software framework, wherein the software framework includes a domain-independent protocol specification language, a protocol generator and a plurality of modular and extensible software modules configured to operate as a plurality of autonomous economic agents (AEAs), and wherein the plurality of autonomous economic agents (AEAs) are communicably coupled with a plurality of micro-agents (micro-AEAs), the plurality of micro-agents (micro-AEAs) being communicably coupled with each other; and
an external computing arrangement comprising a plurality of external computing devices, wherein the plurality of external computing devices is part of a distributed ledger arrangement upon which a co-learning software module and a plurality of external machine learning (ML) models are implemented, wherein the co-learning software module is communicably coupled to the plurality of external machine learning (ML) models, and wherein within the system:
a given micro-agent (micro-AEA), is configured to generate an invocation of the protocol generator for generating at least one protocol for a protocol specification, upon receiving a service request to perform an action from a client-agent (Client-AEA), to incorporate a given external machine learning (ML) model from amongst the plurality of external machine learning (ML) models, and to transmit the protocol specification to the plurality of external computing devices;
the plurality of external computing devices is configured to receive, from the given micro-agent (micro-AEA), the invocation for generating the at least one protocol for the protocol specification, and to generate an insight corresponding to the action, using the given external machine learning (ML) model and/or the co-learning software module and to transmit the insight to the given micro-agent (micro-AEA);
the given micro-agent (micro-AEA) is configured to receive the insight from the plurality of external computing devices and to transmit metadata corresponding to the protocol specification and the received insight to the plurality of external computing devices;
upon receiving the metadata from the given micro-agent (micro-AEA), the plurality of external computing devices is configured to generate an inference by applying the insight and the metadata to the given external machine learning (ML) model and/or the co-learning software module, and to transmit the inference to the given micro-agent (micro-AEA); and
the given protocol generator is configured to generate an implementation of the at least one protocol to implement the protocol specification using the inference and the domain-independent protocol specification language.

2. The system of claim 1, wherein the given micro-agent (micro-AEA) is configured to execute the generated at least one protocol such that the action associated with the service request, received by the client- agent, is executed.

3. The system of claim 1, wherein when the co-learning software module is configured to generate the insight corresponding to the action, the co-learning software module is configured to engage with the plurality of external machine learning (ML) models for receiving learnings of the plurality of external machine learning (ML) models, wherein the engagement of the co-learning software module with the plurality of external machine learning (ML) models occurs without sharing metadata of any external machine learning (ML) model with other external machine learning (ML) models.

4. The system of claim 2, when the co-learning software module is configured to generate the inference related at least to the protocol specification, the co-learning software module is configured to analyse the meta data and the learnings of the plurality of external machine learning (ML) models in respect of each other, and to generate the inference based on said analysis.

5. The system of claim 1, wherein the given external machine learning (ML) model is communicably coupled to at least one other external machine learning (ML) model of at least a second micro-agent (micro-AEA), and wherein when the given external machine learning (ML) model is configured to generate the insight corresponding to the action, the given external machine learning (ML) model is configured to engage with the at least one other external machine learning (ML) model for receiving learnings of the at least one other external machine learning (ML) model, wherein the engagement of the given external machine learning (ML) model with the at least one other external machine learning (ML) model occurs without sharing metadata of the at least one other external machine learning (ML) model with the given external machine learning (ML) model.

6. The system of claim 4, wherein when the given external machine learning (ML) model is configured to generate the inference related at least to the protocol specification, the given external machine learning (ML) model is configured to analyse the metadata, its learnings, and the learnings of the at least one other external machine learning (ML) model in respect of each other, and generate the inference based on said analysis.

7. The system of claim 1, wherein the insight comprises at least one of:
a requirement to generate the implementation of the at least one protocol corresponding to the protocol specification, to fulfil the service request;
a possibility to reuse at least one of: one or more existing protocols for the given micro-agent (micro-AEA), one or more existing skills of the given micro-agent (micro-AEA), one or more existing connections supported by the given micro-agent (micro-AEA); and
a requirement to generate at least one of: a new protocol, a new connection, a new skill.

8. The system of claim 1, wherein the metadata comprises at least one of: a technological setup of the given micro-agent (micro-AEA), one or more protocols for the given micro-agent (micro-AEA), one or more skills of the given micro-agent (micro-AEA), one or more connections supported by the given micro-agent (micro-AEA), the service request received by the given micro-agent (micro-AEA).

9. The system of claim 7, wherein the technological setup of the given micro-agent (micro-AEA) comprises at least one of: a programming language in which the given micro-agent (micro-AEA) is created, an operating system of the given micro-agent (micro-AEA), a library available to the given micro-agent (micro-AEA), an amount of computational resources available with the given micro-agent (micro-AEA), a platform that the given micro-agent (micro-AEA) runs on.

10. The system of claim 1, wherein the inference comprises at least one of:
a recommendation of how to produce the implementation of the at least one protocol corresponding to the protocol specification, to fulfil the service request;
a recommendation of how to combine at least one of: one or more existing protocols for the given micro-agent (micro-AEA), one or more existing skills of the given micro-agent (micro-AEA), one or more existing connections supported by the given micro-agent (micro-AEA), to create a new functionality for the client- agent corresponding to the service request; and
a recommendation of how to generate at least one of: a new protocol, a new connection, a new skill, to fulfil the service request.

11. The system of claim 1, wherein the decentralised computing network comprises a plurality of computing devices that are communicably coupled to each other, and wherein each of the plurality of computing devices comprises at least one processor, at least one memory device, and a communication interface.

12. A method for enabling application of autonomous economic agents (AEAs) across a plurality of problem domains, the method comprising:
generating, from a given micro-agent (micro-AEA) communicably coupled with a plurality of modular and extensible software modules configured to operate as a plurality of autonomous economic agents (AEAs) of a software framework, an invocation of a protocol generator of the software framework for a protocol specification, upon receiving a service request to perform an action from a client- agent (client-AEA), incorporating a given external machine learning (ML) model from amongst a plurality of external machine learning (ML) models and transmitting the protocol specification to the plurality of external computing devices
receiving, using the plurality of external computing devices, the invocation for generating the at least one protocol for the protocol specification from the given micro-agent (micro-AEA), and generating an insight corresponding to the action, using the plurality of external computing devices and transmitting the insight to the given micro-agent (micro-AEA), wherein the plurality of external computing devices uses the given external machine learning (ML) model and/or a co-learning software module that is communicably coupled to the plurality of external machine learning (ML) models, wherein the given external machine learning (ML) model and the co-learning software module are implemented upon a distributed ledger arrangement;
receiving, from the given micro-agent (micro-AEA), the insight from the plurality of external computing devices and transmitting metadata corresponding to the protocol specification and the received insight to the plurality of external computing devices;
generating an inference using the plurality of computing devices, upon receiving the metadata from the given micro-agent (micro-AEA), by applying the insight and the metadata to the given external machine learning (ML) model and/or the co-learning software module and transmitting the inference to the given micro-agent (micro-AEA); and
generating an implementation of the at least one protocol to implement the protocol specification using the inference and a domain-independent protocol specification language of the software framework.

13. The method of claim 11, further comprising executing the generated at least one protocol using the given micro-agent (micro-AEA) such that the action associated with the service request, received by the client-agent, is executed.

14. The method of claim 11, wherein when the co-learning software module implements the step of generating the insight corresponding to the action, the method comprises engaging with the plurality of external machine learning (ML) models for receiving learnings of the plurality of external machine learning (ML) models, wherein the engagement of the co-learning software module with the plurality of external machine learning (ML) models occurs without sharing metadata of any external machine learning (ML) model with other external machine learning (ML) models.

15. The method of claim 12, wherein the co-learning software module implements the step of generating the inference related at least to the protocol specification, and wherein the method comprises analysing the metadata and the learnings of the plurality of external machine learning (ML) models in respect of each other, and generating the inference based on said analysis.

16. The method of claim 11, wherein the given external machine learning (ML) model is communicably coupled to at least one other external machine learning (ML) model of a second micro-agent (micro-AEA), and wherein when the given external machine learning (ML) model implements the step of generating the insight corresponding to the action, the method comprises engaging the given external machine learning (ML) model with the at least one other external machine learning (ML) model for receiving learnings of the at least one other external machine learning (ML) model, wherein the engagement of the given external machine learning (ML) model with the at least one other external machine learning (ML) model occurs without sharing metadata of the at least one other external machine learning (ML) model with the given external machine learning (ML) model.

17. The method of claim 11, wherein the given external machine learning (ML) model implements the step of generating the inference related at least to the protocol specification, and wherein the method comprises analysing the metadata, learnings of the given external machine learning (ML) model, and the learnings of the at least one other external machine learning (ML) model in respect of each other, and generating the inference based on said analysis.

18. The method of claim 11, wherein the insight comprises at least one of:
a requirement to generate the implementation of the at least one protocol corresponding to the protocol specification, to fulfil the service request;
a possibility to reuse at least one of: one or more existing protocols for the given micro-agent (micro-AEA), one or more existing skills of the given micro-agent (micro-AEA), one or more existing connections supported by the given micro-agent (micro-AEA); and
a requirement to generate at least one of: a new protocol, a new connection, a new skill.

19. The method of claim 11, wherein the metadata comprises at least one of: a technological setup of the given micro-agent (micro-AEA), one or more protocols for the given micro-agent (micro-AEA), one or more skills of the given micro-agent (micro-AEA), one or more connections supported by the given micro-agent (micro-AEA), the service request received by the given micro-agent (micro-AEA).

20. The method of claim 11, wherein the inference comprises at least one of:
a recommendation of how to produce the implementation of the at least one protocol corresponding to the protocol specification, to fulfil the service request;
a recommendation of how to combine at least one of: one or more existing protocols for the given micro-agent (micro-AEA), one or more existing skills of the given micro-agent (micro-AEA), one or more existing connections supported by the given micro-agent (micro-AEA), to create a new functionality for the client- agent corresponding to the service request; and
a recommendation of how to generate at least one of: a new protocol, a new connection, a new skill, to fulfil the service request.
